(19) United States
(12) Patent Application Publication
(10) Pub. No.: US 2012/0021883 A1
(43) Pub. Date: Jan. 26, 2012

(54) METHOD AND DEVICE FOR MAKING A BAG

(76) Inventor: Philippe Callault, Lisle (FR)

(21) Appl. No.: 12/998,509

(22) PCT Filed: Oct. 29, 2009
(86) PCT No.: PCT/EP2009/064302

§ 371 Date: Sep. 30, 2011

(30) Foreign Application Priority Data
Oct. 31, 2008 (FR) 08 57433

(51) Int. Cl. B31B 1/64

(52) U.S. Cl. 493/189

(57) ABSTRACT

The invention relates to a device for making flexible bags using two stacked films made of a same material, said device comprising a laser source for producing a weld between the two films. The two films are advantageously made of EVA-laden polyethylene. The device further includes cutting means.

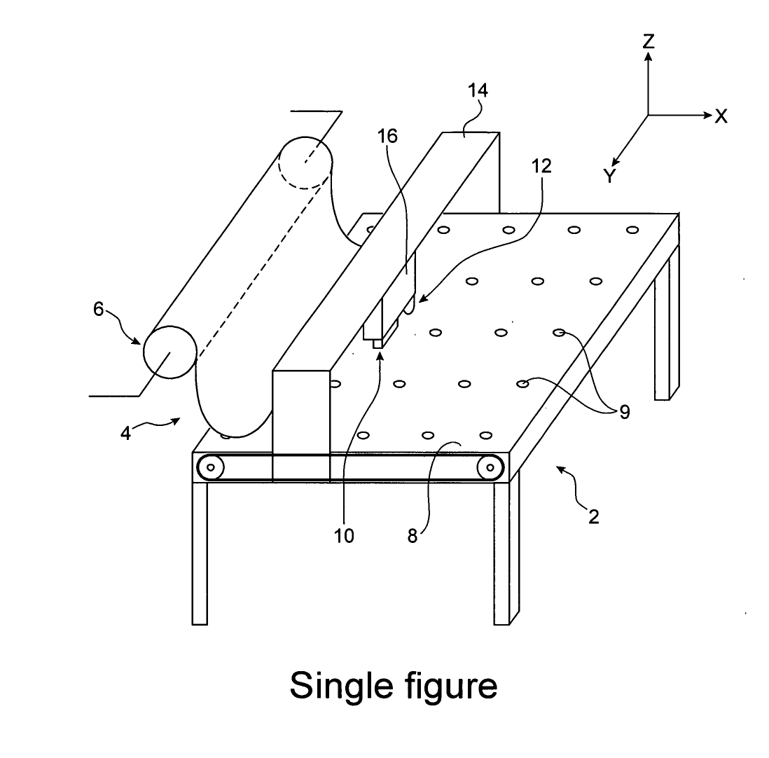

### TECHNICAL FIELD AND PRIOR ART

The present invention relates to a quick and reliable method for making flexible bags, or more generally to a method for making flexible containers, and a device for carrying out such a method for making bags.

The bags in question are for example used to contain objects that need to be isolated from the exterior environment. The objects may be sterile components, for example closures, bottles, syringes, intended to be unloaded on a production line for the pharmaceuticals or agribusiness industries, or wastes from a method of manufacture of the pharmaceuticals, agribusiness or nuclear industry. The bags thus need to have high production quality, while at the same time having a reduced cost price.

These bags are formed by assembly of two films made of flexible plastic using a high frequency welding machine.

A widely known method for making such bags comprises the following steps:
manually cutting out two films from a tubular film with a cutting tool, of cutter type, using a template,
manually and one after the other joining the two films using a high frequency welding machine.

The current method does not enable the formation of complex shapes. Furthermore, the current method does not make it possible to guarantee regularity of the welds over the entire periphery of the bags, which adversely affects their visual appearance and may make it be thought that the bags are of poor quality, whereas they are perfectly sealed. Indeed, the operator has to manually move the welding machine or the two films to produce the weld all around the bag.

Since the welding is carried out manually, its quality depends on the experience of the operator.

Furthermore, the cycle times are long and the working conditions are difficult.

Consequently, an aim of the present invention is to offer a quick and simple method for making flexible bags and offering bags whose visual appearance is improved.

### DESCRIPTION OF THE INVENTION

The aforementioned aim is attained by a method for making bags wherein the joining of the two films made of a same material is obtained by laser weld.

The manufacture is then quick and the welds are regular. Indeed, the laser weld makes it possible to produce a continuous weld.

In a particularly advantageous manner, the material of the films is either a mixture of polyethylene (PE) and ethylene-vinyl acetate (Ethyl Vinyl Acetate or EVA) with a proportion of EVA between 13.5% and 18% by mass, or polyurethane (PU).

Another subject-matter of the present invention is a device for making bags comprising a laser welding station, the laser source moving automatically according to a given programme.

In an advantageous manner, an automatic cutting station is also provided, to cut the tubular film according to the desired shape of the bag after the weld. The present invention then has the advantage of avoiding resorting to a template for the cutting.

Consequently, the main object of the present invention is the use of a laser source to weld two stacked films, said films being made of the same plastic material, to manufacture sealed flexible bags.

The thickness of each of the films is for example between 200 μm and 300 μm.

The two films come advantageously from a tubular film, which facilitates their putting in place since the two films are joined to each other by their lateral edges. Furthermore, the two films are lightly bonded, which improves the welding. Furthermore, this light adhesion is sufficient to avoid the insertion of particles between the two films, the risks of contamination are thus reduced.

Another subject-matter of the present invention is a device for making flexible bags comprising a table, on which are intended to be stacked two films made of flexible material able to be welded using a laser beam, a laser source, means able to produce a relative movement of the laser source and the table and a control unit intended to control said means of movement to produce a weld according to a pre-programmed shape.

For example, the means of movement move the laser source in relation to the table in a plane parallel to the table, which simplifies the device.

The control unit advantageously comprises means for modifying the intensity of the laser beam emitted by the laser source as a function of the geometry of the weld to be produced, which enables the production of a uniform weld.

The device according to the invention, may, in an advantageous manner, comprise cutting means, and means able to produce a relative movement between the cutting means and the table, said means of movement being controlled by the control unit to cut in the weld, or along the weld outside of said weld.

It may be provided that the means of moving the laser source are also intended to move the cutting means.

The device may comprise a spool of films, and a conveyor belt to lay out the films on the table, the actuation of the conveyor belt causing an automatic distribution of the films on the table.

The device for making bags according to the invention may also comprise means for immobilising films on the belt, for example by suction.

Another object of the present invention is a method for making flexible bags using the device for making bags according to the present invention, comprising the steps:
programming the control unit as a function of the shape of the bag for the movement of the laser source,
putting in place two thicknesses of film on the table,
actuating the means of moving the laser source and switching on the laser beam,
moving the laser source according to the programmed shape,
extinction of the laser beam and stopping of the means of moving the laser source,
cutting of the bag in the weld or on the outside of said weld.

In an advantageous manner, the switching on of the laser beam takes place after the laser source has begun to move.

The method for making bags according to the invention may comprise the prior step of focusing the laser beam on the film in contact with the table, which improves the weld.

The method for making bags according to the invention may comprise the step of programming. the control unit for the movement of the cutting means.

The method for making bags according to the invention may comprise the step, after cutting, of evacuation of the bag by expulsion of air through the table.

### BRIEF DESCRIPTION OF DRAWINGS

The present invention will be better understood with the description that follows and the single appended drawing, which is a perspective view of an example of embodiment of a device for making bags according to the present invention.

### DETAILED DESCRIPTION OF SPECIFIC EMBODIMENTS

In the single FIGURE may be seen a schematic representation of a device for making bags according to the present invention.

The device comprises a table 2 on which the two films to be welded are intended to be laid out. In the FIGURE, the films are not laid out on the table.

In the remainder of the description, lower film will designate the film in contact with the table 2, and upper film will designate the film that is not in contact with the table 2.

A XYZ system is defined, X and Y being two orthogonal axes defining a plane parallel to the table and Z being an axis orthogonal to the table.

For example, a flattened tubular film 4 is used, formed of a tubular film, such that it is formed of two stacked films connected by their lateral ends. The tubular film is wound up and forms a reel, the necessary length of film being obtained by unwinding the tubular film 4. The reel is arranged on a spool 6.

The tubular film 4 is formed by extrusion.

In an advantageous manner, the device comprises a conveyor belt 8 to bring the part of the tubular film 4 in which the bag is going to be formed up to the welding spot. The conveyor belt 8 may form the whole surface of the table 2, the welding and the cutting being carried out on this belt 8. This makes it possible to easily bring the part to be welded and to quickly remove the completed bag.

In an advantageous manner, the table 2 comprises means of immobilising the films. For example, they may be means of suction ensuring the tubular film is laid flat on the table. To do this, the table, more particularly the conveyor belt 8, comprises a plurality of orifices 9 connected to a suction system; the tubular film is then maintained at the level of each of the orifices 9. The means of suction may also form means of expulsion of air so as to cause a detachment of the bag once it is finished.

The two films are lightly bonded to each other due to electrostatic forces, thus an immobilisation of the lower film is sufficient to immobilise the two films in relation to the table, and avoids having to resort to means to immobilise the upper film.

According to the invention, the device comprises laser welding means 10.

The welding means 10 comprise a laser source, for example of CO₂ laser type of power between 40 W and 100 W.

The laser source 10 is advantageously focused on the lower film. Thus, the laser beam passes through the upper film, causes the heating of the lower film and the melting of the films. These are then joined by means of a weld. Focusing on the lower film makes it possible to limit heat losses. Indeed, in this case, the heating is confined between the table 2 and the upper film. In the case of focusing on the upper film, the heating would not be confined, part of the heating would not participate in producing the weld, and the weld would then be longer to obtain.

The welding means 10 are motorised so as to be able to be moved along the directions X and Y and enable bags of any shape to be made.

The welding means 10 are controlled by a control unit (not represented) by means of software. The software is configured according to the shape of the bag to be made.

In a particularly advantageous manner, the control unit, in addition to controlling the movement of the laser source 10, also manages the intensity of the laser beam, as a function of the path of the beam. For example, when the laser beam follows a curve, its intensity is reduced so as to avoid excessive overheating. Indeed, such excessive overheating would cause a non-uniformity of the weld all along the contour of the bag. The control unit thus makes the intensity of the laser correspond with the geometry of the weld.

Thus, the smaller the radius of curvature of the curve, the more the intensity of the laser beam is reduced. The weld thus obtained is substantially identical over the whole contour, whatever the successive curved and rectilinear shapes composing the contour.

It is provided that the laser beam does not go beyond the tubular film, in order to avoid burning the table. To do this, for example the control unit is programmed as a function of the dimensions of the tubular film, particularly its width.

During the start of the welding step, the laser beam is advantageously activated after placing in movement the laser source 10, so as to avoid overheating the area where the weld starts.

It has been mentioned previously that the two films are lightly bonded to each other due to electrostatic forces, said light bonding makes it possible to avoid the presence of air between the two films, the quality of the weld is improved. Furthermore, this makes it possible to reduce the necessary intensity of the laser beam.

In an advantageous manner, the device comprises means of cutting 12 the tubular film.

The cutting means 12 comprise a blade. The blade is moved automatically according to a programme defined as a function of the shape of the bag.

The blade 12 is controlled by the control unit which makes the blade follow either a path identical to that of the laser beam, the blade will cut the tubular film in the weld, or a path lining the weld outside of said weld.

The blade, during the cutting of the two films simultaneously, rubs slightly on the table, without damaging it.

The cutting means are moveable along the Z axis to bring the blade 12 into contact with the tubular film and then are moveable along the X and Y axes, to cut the tubular film 4 according to any shape.

By way of example, the device comprises a cross member 14 extending along the Y axis, which is moveable along the X axis, and a trolley 16 moveable on the cross member along the Y axis. Said trolley bears both the blade 12 and the laser source 10. Both the cross member 14 and the trolley 16 are motorised.

Thus, by simultaneously moving the trolley 16 and the cross member 14, it is possible to make the laser source 10 and the blade 12 follow all shapes in a plane parallel to the plane of the table.

It is possible to provide articulating the blade 12 so that, once the weld has been produced, it comes into contact with the tubular film 4.

The position of the laser source 10 is adjustable along the Z axis to enable the focusing of the laser beam. Said adjustment may be manual since it is carried out at the start of the manufacture of a series of bags from one type of tubular film.

To form the films, polyurethane may for example be used.

In a particularly advantageous manner, EVA-laden (ethylene-vinyl acetate) polyethylene is used, the EVA load being between 13.5% and 18% by mass. For example, each of the films has a thickness between 200 μm and 300 μm.

The inventors noted that the interval [13.5%, 18%] for the proportion by mass of EVA made it possible to produce the weld of films of EVA-laden polyethylene using a laser. Indeed, for a proportion of EVA below 13.5%, the laser beam passes through the films without transmitting sufficient thermal energy to melt the films and join them. For a proportion of EVA greater than 18%, the absorption of thermal energy is, quite the opposite, too high, the beam “makes a hole in” the films.

Thanks to this method of producing welds by laser, using tubular films made of polyethylene loaded with EVA in a particular proportion, the time for making a bag is between three and four minutes, whereas manufacture by high frequency welding requires 15 minutes.

Furthermore, the weld obtained is continuous along the entire contour of the bag, since the laser beam remains in contact with the film throughout the entire welding step. Furthermore, due to the management of the intensity of the laser beam as a function of the profile of the weld, this remains uniform.

The different steps of making a bag by the method according to the invention will now be described.

The tubular film 4 is unwound by actuating the conveyor belt, the means of suction also having the function of ensuring an immobilisation of the tubular film 4 on the belt 8, which enables it to follow the belt 8.

When a sufficient length of tubular film 4 has unwound and is in place on the conveyor belt 8, the movement of the belt 8 is stopped.

The laser welding means 10 are then activated.

More specifically, the laser source 10 is placed in movement, then the laser beam is switched on. Beforehand, the vertical position of the laser source 40 has been adjusted so that the laser beam is focused on the lower film.

The control unit controls the movement of the laser beam in the plane XY on the basis of a programmed shape of bag, by commanding the movements of the cross member 14 and the trolley 16.

As described previously, the intensity of the laser beam is adapted as a function of the curve of the contour of the bag.

When the laser beam has followed the entire contour, the laser beam is extinguished.

In a subsequent step, the bag is cut in the weld or outside of said weld.

This cutting may be carried out manually or directly by the device, the blade 12 borne by the trolley 16 making the cut, the movement of the blade 12 being controlled by the control unit.

It is advantageous to cut the films after having carried out the weld, since this limits the handling of the films and makes it possible to ensure that a good adhesion exists between the two films, this adhesion being favourable for the correct operation of the laser weld. Furthermore, this adhesion reduces the risks of contamination of the faces of the film intended to form the inside of the bag, the disbondment of the films having the effect of increasing this risk of contamination.

This device has the advantage of producing a single and continuous weld, which improves the visual appearance of the bag and confirms to the user the quality of said bag, particularly in the quality of its sealing.

Furthermore, the method for making bags is to a large extent automatic, which reduces human interventions. Indeed, thanks to the device according to the invention, the operator only has to actuate the conveyor belt to put in place the tubular film on the table, then start up the laser welding means, then start up the cutting means and evacuating the bag. These actions may be obtained by a simple pressing of separate buttons.

The quality of the weld and the time required to make a bag are then quasi-independent of the operator.

Furthermore, the risk of particulate contamination of the interior faces of the films is reduced, since the handling of the films is limited, these adhere to each other preventing the introduction of particles between the two films.

1. Use of a laser source to weld two stacked films, said films being made of the same material plastic and from a tubular film, to make sealed flexible bags.

2. Use of a laser source according to claim 2, wherein the material of the films is either ethylene-vinyl acetate (EVA) loaded polyethylene, or polyurethane.

3. Use according to claim 2, wherein the EVA load is between 13.5% and 18% by mass.

4. Use of a laser source according to one of claims 1 to 3, wherein the thickness of each of the films is between 200 μm and 300 μm.

5. Device for making flexible bags comprising a table (2) on which are intended to be stacked two films made of flexible material from a single tubular film, able to be welded using a laser beam, a laser source (10), means able to produce a relative movement of the laser source and the table and a control unit intended to control said means of movement to produce a weld according to a pre-programmed shape.

6. Device for making bags according to claim 5, wherein the means of movement move the laser source in relation to the table in a plane (XY) parallel to the table.

7. Device for making bags according to the preceding claim, wherein the control unit comprises means for modifying the intensity of the laser beam emitted by the laser source (10) as a function of the geometry of the weld to be made.

8. Device for making bags according to claim 5, 6 or 7, comprising cutting means (12), and means able to produce a relative movement between the cutting means and the table, said means of movement being controlled by the control unit to cut in the weld or along the weld on the outside of said weld.

9. Device for making bags according to one of claims 5 to 8, wherein the means of movement of the laser source are also intended to move the cutting means.

10. Device for making bags according to one of claims 5 to 9, comprising a spool (6) of films, and a conveyor belt (8) to lay out the films on the table, the actuation of the conveyor belt causing an automatic distribution of the films on the table.

11. Device for making bags according to the preceding claim, comprising means of immobilising films on the belt, for example by suction.

12. Method for making flexible bags using the device for making bags according to one of claims 5 to 11, comprising the steps:
programming the control unit as a function of the shape of the bag for the movement of the laser source (10),
putting in place two thicknesses of film on the table (2) from a tubular film,
actuating means of moving the laser source (10) and switching on the laser beam,
moving the laser source (10) according to the programmed shape,
extinction of the laser beam and stopping of the means of moving the laser source (10),
cutting of the bag in the weld or on the outside of said weld.

13. Method for making bags according to the preceding claim, wherein the switching on of the laser beam takes place after the laser source has begun to move.

14. Method for making bags according to claim 12 or 13, comprising the prior step of focusing the laser beam on the film in contact with the table.

15. Method for making bags according to one of claims 12 to 14, comprising the step of programming the control unit for moving the cutting means (12).

16. Method for making bags according to claim 15, comprising the step, after the cutting, of evacuation of the bag by expulsion of air through the table.
